(19) United States
(12) Patent Application Publication
(10) Pub. No.: US 2026/0217495 A1
(43) Pub. Date: Jul. 30, 2026

(54) RESILIENTLY BIASED ELEVATOR CONNECTOR

(71) Applicant: OTIS ELEVATOR COMPANY, Farmington, CT (US)

(72) Inventors: Yingxin Gao, Farmington, CT (US); Leslie C. Watterson, Unionville, CT (US); Robert Mazzamauro, Meriden, CT (US); Kyle B. Martin, Avon, CT (US)

(21) Appl. No.: 19/037,394

(22) Filed: Jan. 27, 2025

(51) Int. Cl. B66B 7/12; H01R 13/24

(52) U.S. Cl. CPC B66B 7/1223; H01R 13/2407

(57) ABSTRACT

A connector comprises a housing defining an internal cavity and a plurality of contact members received within the internal cavity. Each contact member is resiliently biased to establish an electrically conductive connection with one or more tension members embedded in a suspension member.

### BACKGROUND

Elevator systems are in widespread use for carrying passengers between various levels in buildings. Some elevator systems are traction-based in which a suspension assembly, sometimes referred to as roping, suspends the elevator car and a counterweight. The suspension assembly also facilitates movement of the elevator car when needed. Traditional suspension assemblies include round steel ropes. More recently, elevator systems have included other types of suspension members, such as flat belts or other types of ropes that have tension members encased in a compressible polymer jacket.

Traditional round steel ropes were typically inspected using a manual process including manually and visually observing the condition of the outer surfaces of the rope. Coated belts and other coated ropes cannot be inspected that way. Electrical inspection techniques have been developed that include applying electric current to at least some of the tension members and measuring an electrical characteristic, such as resistance, to obtain information indicating a condition of the belt or coated rope. Connectors are used to connect the coated belts to a monitoring device. Electrical connecting elements are to be properly aligned relative to the connector. The connection is determined by the interaction of several dimensions, which can result in mis-aligned connections.

### SUMMARY

An illustrative example connector includes: a housing defining an internal cavity; and a plurality of contact members received within the internal cavity, wherein each contact member is resiliently biased to establish an electrically conductive connection with one or more tension members embedded in a suspension member.

In addition to one or more of the features described above, or as an alternative, the one or more tension members extend in a first direction along a length of the suspension member, and wherein each contact member is resiliently biased along a path that is generally parallel to the first direction.

In addition to one or more of the features described above, or as an alternative, the plurality of contact members comprise pins.

In addition to one or more of the features described above, or as an alternative, each pin is received within a pin housing having an enclosed first end and an open second end, and wherein each pin housing includes a resilient member reacting between the enclosed first end and a first end of an associated pin.

In addition to one or more of the features described above, or as an alternative, a second end of the associated pin is biased by the resilient member to extend outwardly of the open second end of the pin housing and contact the one or more tension members.

In addition to one or more of the features described above, or as an alternative, each pin housing is held fixed in the internal cavity.

In addition to one or more of the features described above, or as an alternative, the housing comprises a first portion fixable to the suspension member and a second portion selectively securable to the first portion with one or more fasteners.

In addition to one or more of the features described above, or as an alternative, the plurality of contact members are received within the second portion.

In addition to one or more of the features described above, or as an alternative, the housing comprises a single-piece housing that is selectively insertable onto one end of the suspension member.

In addition to one or more of the features described above, or as an alternative, the suspension member has one portion with a section cut that exposes ends of the one or more tension members.

An illustrative example elevator system includes: an elevator car; at least one suspension member that supports the elevator car and facilitates movement of the elevator car, wherein the at least one suspension member includes a plurality of tension members encased in a jacket, and wherein the at least one suspension member includes a portion with exposed ends of the plurality of tension members; a connector defining an internal cavity that receives the portion of the at least one suspension member with exposed ends; and a plurality of contact members received within the internal cavity, wherein each contact member is resiliently biased to establish an electrically conductive connection with at least one tension member of the plurality of tension members.

In addition to one or more of the features described above, or as an alternative, the plurality of tension members extend in a first direction along a length of the at least one suspension member, and wherein each contact member is resiliently biased along a path that is generally parallel to the first direction.

In addition to one or more of the features described above, or as an alternative, the plurality of contact members comprise pins.

In addition to one or more of the features described above, or as an alternative, each pin is received within a pin housing having an enclosed first end and an open second end, and wherein each pin housing includes a resilient member reacting between the enclosed first end and a first end of an associated pin, and wherein a second end of the associated pin is biased by the resilient member to extend outwardly of the open second end of the pin housing and contact one or more tension members of the plurality of tension members.

In addition to one or more of the features described above, or as an alternative, the connector comprises a first housing portion fixable to the at least one suspension member and a second housing portion selectively securable to the first housing portion with one or more fasteners, and wherein the plurality of contact members are received within the second housing portion.

In addition to one or more of the features described above, or as an alternative, the connector comprises a single-piece housing that is selectively insertable onto one end of the at least one suspension member.

In addition to one or more of the features described above, or as an alternative, the plurality of contact members are connectable to an RBI connector.

An illustrative example method includes: exposing ends of a plurality of tension members embedded in a jacket of a suspension member; inserting one portion of the suspension member that includes exposed ends into an internal cavity of a connector; resiliently biasing a plurality of contact members in a direction toward the exposed ends of the plurality of tension members; and establishing electrically conductive connections between the plurality of contact members and the plurality of tension members in the suspension member in response to engagement between the plurality of contact members and the plurality of tension members.

In addition to one or more of the features described above, or as an alternative, the plurality of tension members extend in a first direction along a length of the suspension member, and the method includes resiliently biasing each contact member along a path that is generally parallel to the first direction.

In addition to one or more of the features described above, or as an alternative, each contact member comprises a pin that is received within a pin housing having an enclosed first end and an open second end, and the method includes installing a resilient member in each pin housing to react between the enclosed first end and a first end of an associated pin, and biasing a second end of the associated pin with the resilient member to extend outwardly of the open second end of the pin housing to contact one or more tension members of the plurality of tension members.

The various features and advantages of an example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIG. 2 schematically illustrates a portion of an example suspension member.

FIG. 3 schematically illustrates one example of a connector for an elevator suspension member.

FIG. 4 schematically illustrates another example of a connector for an elevator suspension member.

FIG. 5A schematically illustrates one example of a spring-loaded contact for the connector.

FIG. 5B is a schematic cross-section of the spring-loaded contact of FIG. 5A.

FIG. 6 is a flowchart diagram of an example implementation of the method of assembly.

### DETAILED DESCRIPTION

Embodiments of this disclosure provide a connector including a housing defining an internal cavity. A plurality of contact members are received within the internal cavity, and each contact member is resiliently biased to establish an electrically conductive connection with one or more tension members embedded in a suspension member.

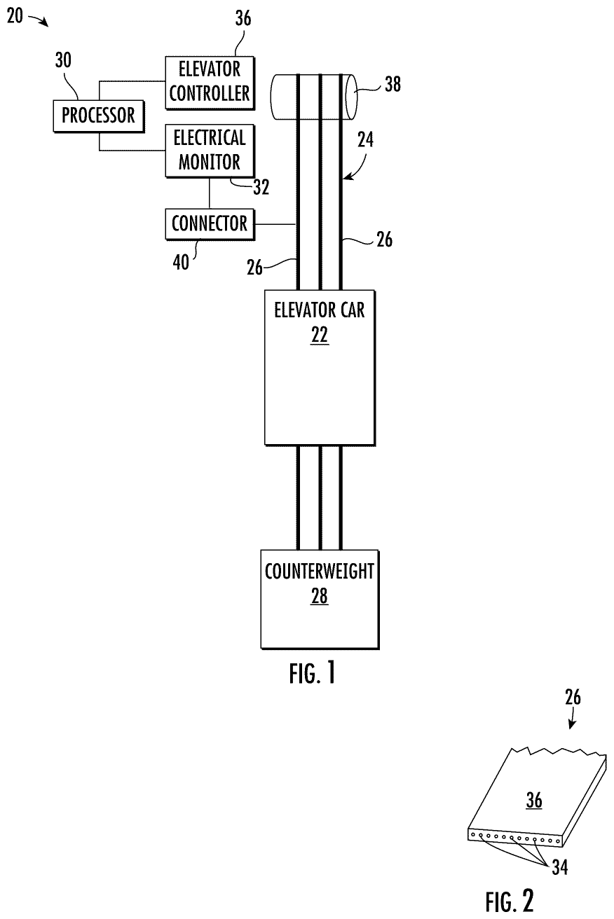

FIG. 1 schematically illustrates selected portions of an elevator system 20. An elevator car 22 is supported by a roping arrangement or suspension assembly 24 that includes a plurality of suspension members 26. The elevator car 22 is also coupled to a counterweight 28 by the suspension members 26. The suspension members 26 move around a sheave 38 as the elevator car 22 moves between landings or levels.

A suspension member monitoring device includes at least one processor 30 that is configured to determine a condition of each of the suspension members 26. The processor 30 in the illustrated example includes a computing device and associated memory. The processor 30 is programmed or otherwise configured to use different types of information indicative of the respective conditions of the suspension members 26 and a combination of criteria to determine when it is desirable or necessary to remove any one of the suspension members 26 from service.

An electric-based monitor 32 uses an electrical inspection technique and generates or provides a corresponding indication regarding a condition of each suspension member 26. The processor 30 receives the indication from the electric-based monitor 32.

In some example embodiments, the electric-based monitor 32 is configured to apply electricity to at least one of the tension members, such as a steel cord, of each suspension member 26 and to detect or measure the electrical resistance of the tension member. Changes in the electrical resistance indicate changes in a condition of the suspension member 26. Such resistance-based inspection techniques are known and need not be further described here.

FIG. 2 schematically illustrates a portion of an example suspension member 26. In the illustrated embodiment, the suspension member 26 is a flat belt including a plurality of tension members 34 encased in a jacket 36 of a compressible material, such as polyurethane. In many embodiments, the tension members 34 comprise steel cords. Other embodiments include tension members that are made of different materials. The electrical inspection technique takes advantage of the electrically conductive nature of the tension members 34.

A connector 40 is used to connect the electric-based monitor 32 to an associated suspension member 26 (FIG. 1). In one example, the electric-based monitor 32 wirelessly communicates the electrical resistance information to the processor 30.

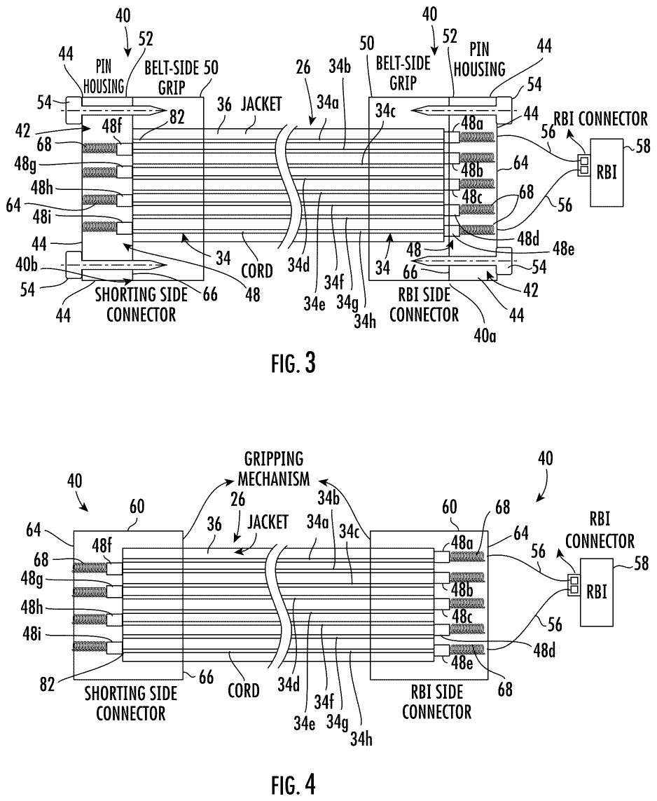

In an example, the connector 40 defines an internal cavity 42 that is enclosed by a plurality of walls 44. One portion of the suspension member 26 extends into the internal cavity 42 as shown in FIG. 3.

The connector 40 further includes a plurality of contact members 48 that establish electrically conductive connections with the tension members 34 in the suspension member 26. In an example, each contact member 48 is arranged to contact one or more of the tension members 34 to provide the electrical resistance information for all of the tension members 34. If there is mis-alignment and one of the tension members 34 does not have an electrically conductive connection with one of the contact members 48, there would be no electrical resistance information available for that tension member 34.

In an example, a proper alignment comprises a configuration where each tension member 34 is in contact with one of the contact members 48 as shown in FIG. 3.

In some implementations, there is a RBI connector 40a and a shorting side connector 40b. RBI connectors play a vital role in ensuring the proper functioning of the electrical systems associated with the suspension members 26, e.g., belts, such as monitoring, power supply, and signal transmission. For example, the RBI connector 40a may provide electrical power to sensors or devices monitoring the belt's condition. Additionally, the RBI connector 40a may transmit data between the elevator's control system and belt-monitoring sensors, while also connecting other devices such as load sensors, belt wear monitors, or speed regulators. The shorting side connector 40b is typically used to short-circuit specific points in the electrical system temporarily for testing, maintenance, or safety purposes, for example. This ensures that circuits are not live while being worked on.

In the example shown in FIG. 3, there are eight tension members 34a-h and five contact members 48a-e for the RBI connector 40a and four contact members 48f-i for the shorting side connector 40b.

In this example, when properly aligned in the RBI connector 40a, contact member 48a only contacts tension member 34a and contact member 48e only contacts tension member 34h. In this example, the remaining contact members are arranged as follows: contact member 48b is at a location that is between two adjacent tension members 34b, 34c; contact member 48c is at a location that is between two adjacent tension members 34d, 34e; and contact member 48d is at a location that is between two adjacent tension members 34f, 34g.

In this example, when properly aligned in the shorting side connector 40b, the contact members are arranged as follows: contact member 48f is at a location that is between two adjacent tension members 34a, 34b; contact member 48g is at a location that is between two adjacent tension members 34c, 34d; contact member 48h is at a location that is between two adjacent tension members 34e, 34f; and contact member 48i is at a location that is between two adjacent tension members 34g, 34h.

It should be understood that while eight tension members and five and/or four contact members are shown as one example, and the number of tension and contact members can be varied as needed.

In some implementations, the RBI connector 40a and the shorting side connector 40b each include a housing that supports the contact members 48. In the example of FIG. 3, each housing is comprised of a belt-side grip portion 50 and a contact member portion 52 that is selectively attached to the belt-side grip portion 50.

The belt-side grip portion 50 may be fixed to the jacket 36 of the suspension member 26 using any type of attachment method, e.g., fastening, adhering, etc.

In an example, the contact member portion 52 is attached to the belt-side grip portion 50 using one or more fasteners 54. In the example shown, the fasteners 54 are screws that are screwed into the belt-side grip portion 50. Other types of attachment may also be used.

In an example, the contact members 48 are located within the contact member portion 52 and associated wiring 56 is used to communicate the electrical connection between the contact members 48 and the tension members 34 to a RBI connector body 58.

FIG. 4 shows another example of a connector that is similar to that of FIG. 3, but instead of having a two-piece housing, this configuration has a single-piece housing 60. In this example, the contact members 48 are positioned within the internal cavity 42 of the housing 60, and the housing 60 is fixed to the jacket 36 of the suspension member 26. The housing 60 may be fixed to the jacket 36 of the suspension member using any type of attachment method, e.g., fastening, adhering, etc.

In some implementations, the plurality of contact members 48 are received within the internal cavity 42 of the contact member portion 52 or housing 60, and each contact member 48 is resiliently biased to establish the electrically conductive connection with one or more tension members 34 embedded in the jacket 36.

In an example, the tension members 34 extend in a first direction along a length of the suspension member 26 and each contact member 48 is resiliently biased along a path that is generally parallel to the first direction.

In an example, the plurality of contact members 48 comprise pins 62 as shown in FIGS. 5A-5B. As shown in the figures, the pins 62 are received within housing portions that have an enclosed first end 64 and an open second end 66. In an example, there is a resilient member 68 reacting between the enclosed first end 64 and a first end 70 of an associated pin 62.

In an example, a second, distal end 72 of the associated pin 62 is biased by the resilient member 68 to extend away from the enclosed first end 64 and toward the open second end 66 of the housing to contact the one or more tension members 34.

In some implementations, the pins 62 are formed as cylindrical bodies that are located within individual pin housings 74. A cap 76 encloses one end of the pin housing 74 and the resilient member 68 is positioned between the cap 76 and the first end 70 of the pin body as shown in FIGS. 5A-B. The resilient member 68 biases the second, distal end 72 outwardly of an open end of the pin housing 74.

In an example, each pin housing 74 is held fixed in the internal cavity 42.

In some implementations, the suspension member 26 has one or more portions with a section cut 80 that exposes ends 82 (FIG. 4) of the tension members 34. The pins 62 are positioned such that the second, distal ends 72 directly engage the exposed end faces of the tension members 34.

The spring-loaded mechanism also accommodates for uneven cross-sectional surface as demonstrated by the examples associated with contact members 48a, 48g or 48h as shown in FIG. 3.

In an example, the resilient biasing force is directed in a direction that is parallel to a length of the tension members 34.

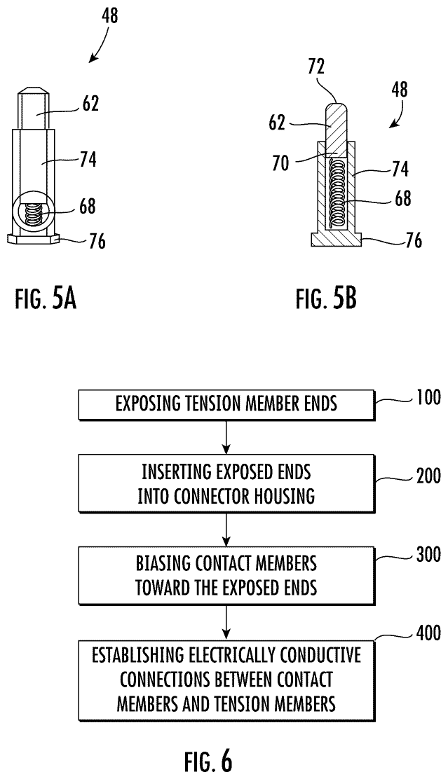

A method of assembly is also disclosed. FIG. 6 is a flowchart diagram of an example implementation of the method of assembly.

In an example, the method comprises: exposing ends of a plurality of tension members embedded in a jacket of a suspension member (100); inserting one portion of the suspension member that includes exposed ends into an internal cavity of a connector (200); resiliently biasing a plurality of contact members in a direction toward the exposed ends of the plurality of tension members (300); and establishing electrically conductive connections between the plurality of contact members and the plurality of tension members in the suspension member in response to engagement between the plurality of contact members and the plurality of tension members (400).

The method may include any of the additional features and/or steps either alone or in any combination thereof.

In an example, the plurality of tension members extend in a first direction along a length of the suspension member, and the method includes resiliently biasing each contact member along a path that is generally parallel to the first direction.

In an example, each contact member comprises a pin that is received within a housing having an enclosed first end and an open second end, and the method includes installing a resilient member in each housing to react between the enclosed first end and a first end of an associated pin, and biasing a second end of the associated pin with the resilient member to extend outwardly of the open second end of the housing to contact one or more tension members of the plurality of tension members.

In some prior implementations, the spacing between tension members, e.g., cord spacing, may be very close together, which provides a challenge in designing a connector that can avoid the shorting. The present disclosure describes an innovative connector design that enables easy installation of the disclosed connector without requiring vertical penetration through the associated jacket and the cords. In an example, the connector makes electrical contact with the cords by touching a cross-section of the cords using spring-loaded contacts, e.g., pogo pins. In an example, the pins are connected to springs that are in a compressed state to ensure constant contacts between the pins and the cross-section surface of the cords. The spring-loaded mechanism also accommodates the uneven cross-sectional surface of a belt end. In an example, to connect the connector to the belt, a belt-side grip housing may be connected to the end of the belt by a gripping mechanism, and the pin housing may then be tightly connected, e.g., fastened or screwed in, to the belt-side grip housing to ensure full contact between the cord cross-section and the tips of the pistons comprising the pins. This unique configuration will significantly simplify the field installation as well as reduce the risk of any possibility of shorting induced by the connector.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A connector comprising:
a housing defining an internal cavity; and
a plurality of contact members received within the internal cavity, wherein each contact member is resiliently biased to establish an electrically conductive connection with one or more tension members embedded in a suspension member.

2. The connector of claim 1, wherein the one or more tension members extend in a first direction along a length of the suspension member, and wherein each contact member is resiliently biased along a path that is generally parallel to the first direction.

3. The connector of claim 1, wherein the plurality of contact members comprise pins.

4. The connector of claim 3, wherein each pin is received within a pin housing having an enclosed first end and an open second end, and wherein each pin housing includes a resilient member reacting between the enclosed first end and a first end of an associated pin.

5. The connector of claim 4, wherein a second end of the associated pin is biased by the resilient member to extend outwardly of the open second end of the pin housing and contact the one or more tension members.

6. The connector of claim 4, wherein each pin housing is held fixed in the internal cavity.

7. The connector of claim 1, wherein the housing comprises a first portion fixable to the suspension member and a second portion selectively securable to the first portion with one or more fasteners.

8. The connector of claim 7, wherein the plurality of contact members are received within the second portion.

9. The connector of claim 1, wherein the housing comprises a single-piece housing that is selectively insertable onto one end of the suspension member.

10. The connector of claim 1, wherein the suspension member has one portion with a section cut that exposes ends of the one or more tension members.

11. An elevator system, comprising:
an elevator car;
at least one suspension member that supports the elevator car and facilitates movement of the elevator car, wherein the at least one suspension member includes a plurality of tension members encased in a jacket, and wherein the at least one suspension member includes a portion with exposed ends of the plurality of tension members;
a connector defining an internal cavity that receives the portion of the at least one suspension member with exposed ends; and
a plurality of contact members received within the internal cavity, wherein each contact member is resiliently biased to establish an electrically conductive connection with at least one tension member of the plurality of tension members.

12. The elevator system of claim 11, wherein the plurality of tension members extend in a first direction along a length of the at least one suspension member, and wherein each contact member is resiliently biased along a path that is generally parallel to the first direction.

13. The elevator system of claim 11, wherein the plurality of contact members comprise pins.

14. The elevator system of claim 13, wherein each pin is received within a pin housing having an enclosed first end and an open second end, and wherein each pin housing includes a resilient member reacting between the enclosed first end and a first end of an associated pin, and wherein a second end of the associated pin is biased by the resilient member to extend outwardly of the open second end of the pin housing and contact one or more tension members of the plurality of tension members.

15. The elevator system of claim 11, wherein the connector comprises a first housing portion fixable to the at least one suspension member and a second housing portion selectively securable to the first housing portion with one or more fasteners, and wherein the plurality of contact members are received within the second housing portion.

16. The elevator system of claim 11, wherein the connector comprises a single-piece housing that is selectively insertable onto one end of the at least one suspension member.

17. The elevator system of claim 11, wherein the plurality of contact members are connectable to an RBI connector.

18. A method comprising:
exposing ends of a plurality of tension members embedded in a jacket of a suspension member;
inserting one portion of the suspension member that includes exposed ends into an internal cavity of a connector;
resiliently biasing a plurality of contact members in a direction toward the exposed ends of the plurality of tension members; and
establishing electrically conductive connections between the plurality of contact members and the plurality of tension members in the suspension member in response to engagement between the plurality of contact members and the plurality of tension members.

19. The method of claim 18, wherein the plurality of tension members extend in a first direction along a length of the suspension member, and including resiliently biasing each contact member along a path that is generally parallel to the first direction.

20. The method of claim 18, wherein each contact member comprises a pin that is received within a pin housing having an enclosed first end and an open second end, and including installing a resilient member in each pin housing to react between the enclosed first end and a first end of an associated pin, and biasing a second end of the associated pin with the resilient member to extend outwardly of the open second end of the pin housing to contact one or more tension members of the plurality of tension members.
